(19) United States
(12) Patent Application Publication
(10) Pub. No.: US 2003/0061024 A1
(43) Pub. Date: Mar. 27, 2003

(54) Method of determining sequences of terminals or of terminals and wildcards belonging to non-terminals of a grammar

(76) Inventor: Sven C. Martin, Aachen (DE)

Correspondence Address: U.S. Philips Corporation, 580 White Plains Road, Tarrytown, NY, 10591, US

(21) Appl. No.: 10/242,928

(22) Filed: Sep. 13, 2002

(30) Foreign Application Priority Data
Sep. 18, 2001 (DE) 10145913.0

(51) Int. Cl. G06F 17/28

(52) U.S. Cl. 704/4

(57) ABSTRACT

The invention relates to a method of determining sequences of terminals or of terminals and wildcards linked to non-terminals of a grammar in a training corpus of sentences concerning which it is known in each case which non-terminals of the grammar they contain, with the following steps:

determination of sequences of terminals or of terminals and wildcards, and

assignment of the sequences of terminals or of terminals and wildcards to a non-terminal or no non-terminal by means of a classification procedure.

A procedure of this kind may be used, for example, for the automatic learning of the word sequences linked to a semantic grammar in an automated dialog system.

The invention concerns a procedure for determining sequences of terminals or of terminals and wildcards belonging to non-terminals of a grammar. This kind of automatic determination of terminal sequences belonging to non-terminals, which may be interrupted by wildcards where appropriate, is of significance in, for example, the field of automated dialog systems. In addition, however, grammars also play a role in the understanding of language in general and the structure of communication between humans.

Automatic dialog systems are used inter alia for providing information or for executing bank transactions by telephone or at public user terminals. Known systems are, for example, the timetable information system of the Swiss Railways and the flight information system of the German company Lufthansa. But the IVR (Interactive Voice Response) systems from various suppliers, such as Periphonics, for example, may also be included. Something all these systems have in common is that a user enters into a spoken dialog with a machine in order to obtain the information he requires or to execute the desired transactions. In addition to the spoken interaction, further media such as visual monitor displays or the sending of faxes are offered in the newer systems.

In order to process a user inquiry, an automated dialog system has to extract the significant components of the inquiry and render them in a form that can be machine processed. In the case of timetable information, for example, if the inquiry is “I would like to travel from Berlin to Munich”, the components “from Berlin” and “to Munich” have to be extracted and “understood” by the automated system to the extent that “Berlin” is the origin of the journey and “Munich” is the destination. To this end, the system can enter this information in, for example, the corresponding fields of an electronic form: “Origin: Berlin” and “Destination: Munich”.

In order to extract the significant components of an inquiry, predominantly manually produced semantic grammars are used at present. In the above example of the origin of the journey, the following are examples of production rules that could be used:

<Origin>→“from” <City>

<City>→“Berlin”.

The pointed brackets <. . . > here designate the non-terminals of the grammar whose terminals are expressed here in inverted commas “. . . ”. As an alternative to these rules, a grammar may also be used which is flat in the sense that its rules convert its non-terminals directly into terminal sequences. In the above example:

<Origin>→“from Berlin”.

Although very seldom used in practice, the terminal sequences may also be interrupted by wildcards. In the above example, “I would like to travel from Berlin to Munich”, the verb group “would like to travel” is used as an adjunct to the information concerning the origin and destination. A possible production rule for the special verb group <Travel requirement> could therefore look like this:

<Travel requirement>→“would like to travel [ . . . ]”, wherein a wildcard [ . . . ] stands for any interposed terminal sequence.

Owing to the complexity of human language, no grammar covering all linguistic phenomena is yet known. In practice, therefore, special application-related grammars capable of describing the linguistic constructions relevant to the application are developed for each application case. In the above example of timetable information, these include the already mentioned non-terminals (also known as concepts) of origin and destination, as well as, for example, the various constructions for printing out a time or date. Generally, grammars of this kind have hitherto been developed manually, involving a considerable cost factor in setting up and maintaining an application.

Therefore, in order to reduce this manual involvement, methods for the automated learning of grammars have been under investigation for some years. Many of these methods are based on a training corpus of specimen sentences for the application to be developed, these being obtained by, for example, logging the dialogs of an already existing application, serving, where applicable, human operators. Further, some of the methods also require manual annotation of these sentences, i.e. a person records for each sentence what non-terminals it contains, as well as, where applicable, the order in which these occur and which terminals of the sentence belong to which non-terminals. Although annotation of this kind does indeed necessitate a certain amount of manual work, this is generally less demanding and less costly than manually creating a grammar.

For the training sentence “I would like to travel from Berlin to Munich”, the annotation could be, for example, that the order of the non-terminals is as follows: “<Travel requirement><Origin><Destination>” and that the following sequences belong thus: “would like to travel” belongs to <Travel requirement>, “from Berlin” to <Origin>, and “to Munich” to <Destination>. (To establish the position of the non-terminal belonging to a sequence of terminals and wildcards, account has been taken here of the position of the first terminal of the sequence in the sentence). Alternatively, however, an annotation could simply note that the training sentence contains the non-terminals “<Origin>”, “<Destination>” and “<Travel requirement>” without specifying their order and/or their related sequences of terminals or of terminals and wildcards.

The paper “K. Macherey, F. J. Och, H. Ney: Natural Language Understanding Using Statistical Machine Translation”, presented at Eurospeech 2001 (7^{th} European Conference on Speech Communication and Technology, Aalborg, Denmark, September 2001) (got already pre-published on the internet under the URL http://www-i6.informatik.rwth-aachen.de/˜och/eurospeech2001.ps) deals with the problem of the automatic learning of a grammar. However, the paper does not concentrate on the explicit learning of a grammar, but instead looks at the question of which non-terminals belong to a sentence constructed from terminals as a translation problem. Working on the basis of a training corpus of specimen sentences annotated with the order of the non-terminals belonging to them, translation structures which translate a sentence constructed from terminals into an associated sequence of non-terminals are learned. To this end, known methods from statistical machine translation are used.

A special feature of the paper mentioned is the use of alignment templates. These are linked sequences or phrases of words in the source language or of words in the target language of the translation, i.e. of terminal and non-terminal sequences in the present application, as well as information on which word positions of the source and target sequences are linked. As an example of an alignment template of this kind, the paper cites inter alia the template:

Source sequence: “from $CITY to $CITY”

Target sequence: “@origin @destination”

Word position linkage:

“from $CITY”⇄@origin

“to $CITY”⇄@destination

“$CITY” is any city (from a list of cities) and the non-terminals @origin and @destination correspond to the above-mentioned <Origin> and <Destination>.

However, these alignment templates, which are automatically determined in the training of the statistical translation structures, are closely related to flat grammars. The above template may, for example, be understood to the effect that the terminal sequence “from Berlin”, which becomes “from $CITY” after categorization (Berlin belongs to the category $CITY), is a possible solution to the non-terminal @origin.

In addition to the alignment templates, a large number of further parameters also have to be estimated in the procedure outlined by Macherey et al. These include phrase alignment probabilities, probabilities of applying alignment templates, and word translation probabilities (p(fⱼ|eᵢ)). For a reliable estimate of such a large number of parameters, a correspondingly comprehensive training corpus is required. As already stated, the training sentences must also be annotated with the order of the linked non-terminal sequence in each case. Therefore, this procedure also necessitates a correspondingly high input.

It is an object of the invention to indicate a method and a system for executing this method which allows the determination of sequences of terminals or of terminals and wildcards linked to non-terminals of a grammar in a training corpus of sentences which is small in comparison with the prior art, concerning which sentences it is known in each case which non-terminals of the grammar they contain.

This object is achieved, on the one hand, by:

a method of determining sequences of terminals or of terminals and wildcards linked to non-terminals of a grammar in a training corpus of sentences concerning which it is known in each case which non-terminals of the grammar they contain, with the following steps:

determination of sequences of terminals or of terminals and wildcards, and

assignment of the sequences of terminals or of terminals and wildcards to a non-terminal or no non-terminal by means of a classification procedure,

and, on the other hand, by:

a system for determining sequences of terminals or of terminals and wildcards linked to non-terminals of a grammar in a training corpus of sentences concerning which it is known in each case which non-terminals of the grammar they contain, which is provided:

for determining sequences of terminals or of terminals and wildcards,

for the assignment of sequences of terminals or of terminals and wildcards to a non-terminal or no non-terminal by means of a classification procedure.

The invention thus concentrates on the direct estimation of the sequences of terminals or of terminals and wildcards linked to the non-terminals of the grammar without introducing further parameters to be determined by an estimation. As a result, a training corpus that is small in comparison with the prior art suffices for a reliable estimate of the sequences linked to the non-terminals. Since the sequences are determined automatically in the procedure, the training corpus does not require any annotation whatever regarding the linkage of the sequences observed in the training to the non-terminals.

The dependent claims 2 to 8 claim particularly advantageous embodiments of the invention. Thus claim 2 restricts the method according to the invention to the determination of sequences consisting only of terminals, which is sufficient for many practical applications and avoids unnecessarily complex grammars in these. It is stated in claim 3 that, for determining the sequences of terminals or of terminals and wildcards, the frequency of these sequences in the training corpus should be taken into consideration. It can thereby be advantageously taken into consideration that there is a high probability that terminals frequently occurring in relationship with one another will be linked to the same non-terminal.

Claim 4 specifies a useful target function, taking account of all incorrect classifications, which is iteratively optimized in the classification of the sequences of terminals or of terminals and wildcards. One of the advantages of this target function is that the order of the non-terminals in the training sentences does not have to be annotated manually since it uses only the information as to which sequences of terminals or of terminals and wildcards and which non-terminals are present in the training sentences. In addition to this target function, however, alternatives are also conceivable. For example, instead of the square (quadratic L2 norm), an absolute distance (L1 norm) may also be used. Furthermore, with an appropriately annotated training corpus, the order of the non-terminals can also be taken into account as an individual contribution in the target function.

In claims 5 and 6, the exchange procedure is used for classification of the sequences. The exchange procedure guarantees an efficient (local) optimization of the target function since only few operations are necessary for calculating the change in the target function upon the execution of an exchange. The listing of the sequences according to their frequency in the training corpus takes account in an advantageous manner of the fact that frequent sequences usually have a greater effect on the optimization of the target function.

In addition, however, further listing rankings are also conceivable. For example, the exchange with the greatest gain in the target function can be undertaken first. In order to save on calculation operations, however, it may be useful not to re-calculate the exchange candidate with the greatest gain after each exchange, but to do this only after a certain waiting period, e.g. after every 100^{th} exchange, once per iteration, or after every 10 iterations. Between the re-calculations, an exchange of the candidates would then be undertaken, for example, in the order of the magnitude of their most recently calculated gains in the target function.

Instead of the exchange of the now existing assignment of each sequence to a non-terminal or no non-terminal with another one, however, other classification procedures may also be used. It could, for example, be established which class, i.e. which non-terminal, makes the highest contribution to the target function, and, by way of example, which sequences of this non-terminal make up the largest proportion of this. These sequences could then be assigned to more suitable non-terminals, i.e. ones in which they make a more favorable contribution to the target function.

The determination of the sequences of terminals or of terminals and wildcards and their assignment to a non-terminal or no non-terminal may take place separately from each other in two successive steps, or may alternatively be combined. Claims 7 and 8 specify two advantageous options for a combination of steps of this kind. If it is established following the execution of the method according to the invention that, in addition to a first sequence, two further sequences have also been determined which, when amalgamated, give rise to the first sequence, in other words: if the first sequence consists of two sub-sequences, then the assignment of these three sequences is of interest. If one sub-sequence is then assigned in exactly the same way as the first sequence, whilst the other sub-sequence is assigned differently, it may be useful to remove the first sequence from the set of sequences determined by the procedure.

A situation of this kind may in fact indicate that the first sequence has no independent meaning, and should instead always be interpreted as an amalgamation of the two sub-sequences. In this case, the use of the first sequence would always lead to the non-terminal belonging to the otherwise assigned sub-sequence being overlooked. Removal of the first sequence would thereby lead to an improvement of the target function. One example of this is the first sequence “from Berlin to Munich”, which in reality always breaks down into the two sub-sequences “from Berlin” and “to Munich” with the non-terminals <Origin> and <Destination> assigned to them.

Following the removal of first sequences of this kind, it is advantageous to repeat the assignment of the sequences to the non-terminals, since during the previous assignment step these first sequences have prevented recognition of the sub-sequences in the sentences in question. It may obviously be provided in the method for a review to be undertaken after these steps of removal and reassignment as to whether the target function has in fact improved and, if it has not, to cancel the steps. Accordingly, different variants of the method may be provided, differing in respect of how many first sequences are removed simultaneously and how often this procedure is repeated.

Whilst the methods specified in claims 7 and 8 combine the determination of the sequences of terminals or of terminals and wildcards and their assignment to non-terminals of a grammar in such a way that these steps take place iteratively and interactively with each other, further options for combining these steps are also possible. Thus, for example, they may also be more intimately combined in that, for example, it has already been taken into account which non-terminals are present in the particular sentences when determining the sequences. In this way, terminals which occur in different sentences can only be amalgamated to form a sequence if these sentences contain at least one identical non-terminal. Furthermore, in assigning the sequence to a non-terminal, the possible candidates for the non-terminal can be restricted to these non-terminals appearing with the sequence in all training sentences.

Claim 10 claims certain sequences of terminals or of terminals and wildcards determined according to the invention as belonging to non-terminals of a grammar. Sequences of this kind can be used in, for example, known syntax analysis processes in order to determine the non-terminals contained in a sentence of the grammar. In particular, they may be used within an automated dialog system to determine the meaning of inquiries directed to it.

These and further aspects and advantages of the invention will be discussed in more detail below with reference to the embodiments and in particular with reference to the appended drawings, in which:

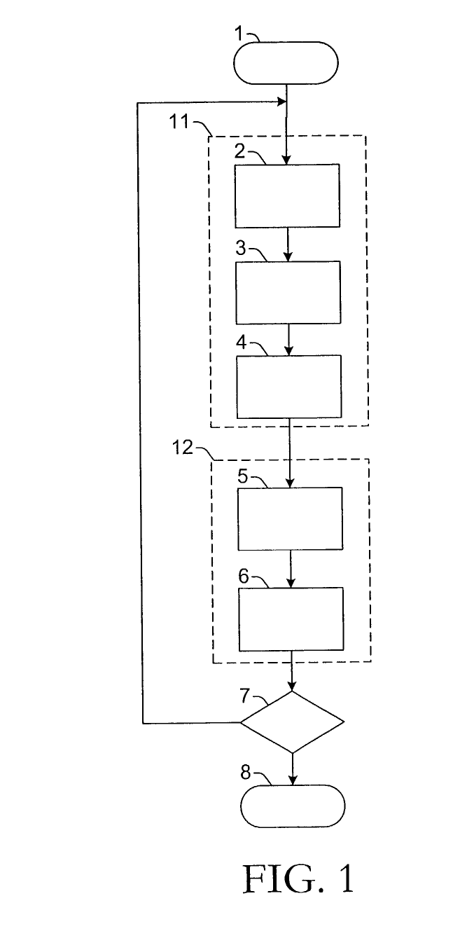

FIG. 1 shows the progression of an algorithm for determining sequences of terminals or of terminals and wildcards in the form of a flowchart, and

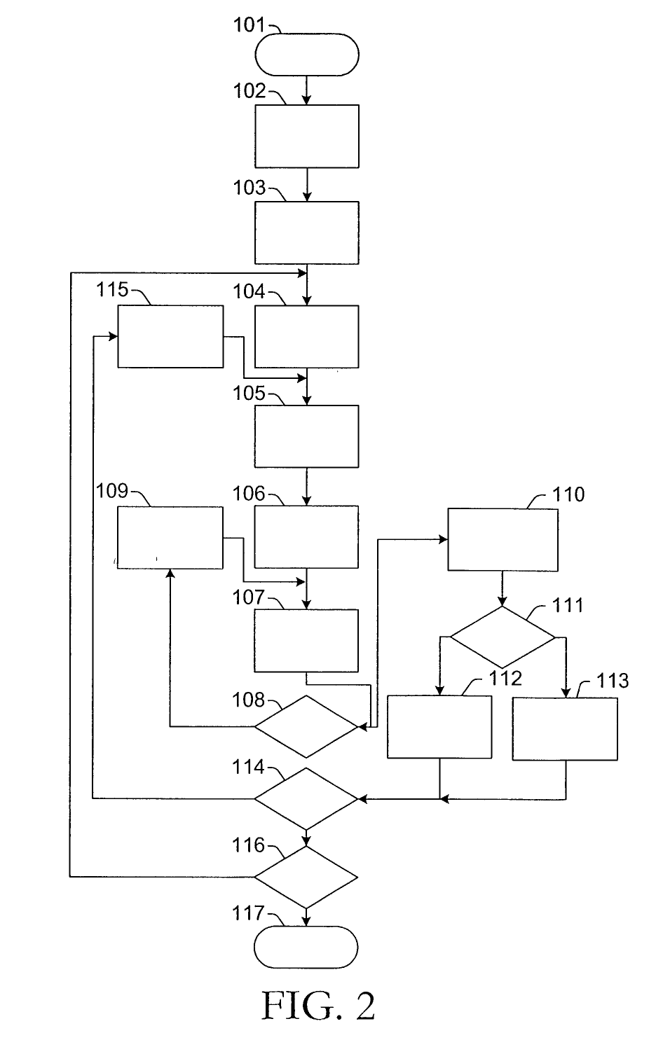

FIG. 2 shows the progression of the exchange algorithm for classification of sequences of terminals or of terminals and wildcards in the form of a flowchart.

FIG. 1 shows the progression of an algorithm for determining sequences of terminals or of terminals and wildcards in the form of a flowchart. This algorithm is taken from the paper “D. Klakow: Language-Model Optimization by Mapping of Corpora, Proc. ICASSP, vol. II, pp. 701-704, Seattle, Wash., May 1998”, which is hereby incorporated into the application. The basic idea of the algorithm consists in that terminals which occur frequently in common sentences in the training corpus are combined so as to form one sequence. The terminals to be combined may be immediately adjacent in the sentences (“standard phrases” in the above paper), may exhibit a specific distance from one another (e.g. always separated from each other by precisely one terminal: “D1 phrases”), or simply fulfil the condition of occurring jointly in a sentence.

The algorithm represents an iterative progression of process block groups 11 and 12, wherein block group 11 serves for forming new sequences of terminals or of terminals and wildcards, and block group 12 serves for dissolving existing sequences. These block groups are run through iteratively in succession until there is no further amendment to the sequences found.

Following initialization in starting block 1, the algorithm enters the succession 11 of process blocks 2, 3 and 4, which checks the creation of new sequences. To this end, a list of the pairs most frequently observed in the training corpus is first produced in block 2. Here, terminals as well as the sequences of terminals or of terminals and wildcards already created in the previous iteration stages, which in this respect replace the terminals contained in them, are used for the pair formation. The list of pairs is sorted according to the frequency of occurrence of the pairs. The length of the list, and thus the calculation and storage input, may be restricted by, for example, the inclusion in the list of pairs with a particular first minimum frequency only.

In block 3, the list is finalized by deletion of the less frequent pairs competing for the same components. Ambiguities of this kind occur when a component of a pair could also be assigned to another pair. In the sentence “I would like to travel from Berlin to Munich”, for example, (according to the categorization of “Berlin” and “Munich” as “$CITY”, also used in the above-mentioned paper by Macherey et al.), the pair formation “from $CITY” competes with “$CITY to”. These ambiguities are eliminated in block 3 by giving preference to the more frequent pairing.

To this end, the list is run through in the order of decreasing frequency and, in order to render the particular pairing “a b” unambiguous, all less frequent pairings “a*≠b” and “*≠a b” are removed from the list, where the symbol “*≠a” stands for any pair component other than “a”, and the symbol “*≠b” stands for any pair component other than “b”. Thus, in the above example, “from $CITY” would probably be more frequent than $CITY to”, since there will probably also be sentences such as “I would like to travel from Berlin” (i.e. without indicating the destination). Therefore, “$CITY to” would be deleted from the list, and only “from $CITY” would remain.

In block 4, the pairs remaining in the list are then amalgamated to form sequences of terminals or of terminals and wildcards, and the sentences of the training corpus are rewritten accordingly. We may, for example, consider the sentence “I would like to travel at nine o'clock” and assume that “nine” will be categorized as “$NUMBER” and that the pairs in the list that are definitive for this sentence are: “would like to travel [ . . . ]” and “$NUMBER o'clock”. This sentence would then be rewritten in block 4 as “I {would like to travel [ . . . ]} at {$NUMBER o'clock}”, wherein the braces “{ }” designate the sequences. In the same way, the sentence “I would like to travel around ten o'clock” would be rewritten as “I {would like to travel [ . . . ]} around {$NUMBER o'clock}”.

Through the formation of new sequences and the associated rewriting of the training corpus, it may happen that previously frequent sequences drop below a certain second minimum frequency. Thus, in the above example, in a further iteration stage, the pair “around {$NUMBER o'clock} could, for example, be amalgamated to form the new sequence “{around {$NUMBER o'clock}}”, as a result of which the frequency of the former sequence “{$NUMBER o'clock}, which is now (directly) perhaps only visible in the combination “around {$NUMBER o'clock}” falls below the second minimum frequency. The algorithm published in the Klakow paper therefore provides for a sequence dissolution block 12, comprising sub-blocks 5 and 6, between every two sequence forming blocks 11.

After block 4, therefore, a list of the sequences of terminals or of terminals and wildcards with a frequency lower than a second minimum frequency is created in block 5. In block 6, these sequences are split up again in that the last pair creation that has led to the sequence is cancelled. The sequence “{around {$NUMBER o'clock}}” would be broken down again into its components “around” and “{$NUMBER o'clock}”.

This sequence dissolution block 12 accordingly follows the basic idea that sequences should only be retained if they fulfil a certain second minimum frequency criterion. The algorithm may, however, also be run without this breakdown step, to which end this second minimum frequency can be set at 0. In particular, by selecting the criteria of first and second minimum frequency, the number of sequences found can be controlled.

After block 6, a check is made in decision block 7 as to whether the processing of block groups 11 and 12 has brought about a change in the sequences found. If this is the case, the algorithm enters its next iteration stage and reenters block 2. Otherwise, the algorithm is terminated in end block 8 and the sequences found are saved.

The algorithm thus described for determining sequences of terminals or of terminals and wildcards is only one option for determining such sequences according to their relative frequency in the training corpus. As an alternative, there are also other techniques from N-Gramm and, in particular, Varigramm language modeling that are known to those skilled in the art. Moreover, instead of the criterion of frequency of a sequence in the training corpus, other criteria, such as the “mutual information” of the pair components, as in the Klakow paper, can also be used.

FIG. 2 shows the succession of the exchange algorithm for classification of sequences of terminals or of terminals and wildcards in the form of a flowchart. In its general, abstract form, the exchange algorithm is well known from, for example, “R. O. Duda, P. E. Hart, D. G. Stork: Pattern Classification. 2^{nd} Ed. J. Wiley & Sons, NY, 2001, Section 10.8: Iterative Optimization”, which is hereby included in this application. However, its application to the problem of assigning sequences of terminals or of terminals and wildcards, once they have been determined, to the non-terminals of the grammar, or establishing that a sequence does not belong to any of the non-terminals, demands a concretizing and corresponding transference of its components.

The basic idea of the exchange algorithm is that, for every existing assignment of a sequence to a non-terminal or no non-terminal, a check is made as to whether, by changing this assignment, a better conformance with the distribution of the non-terminals existing in the training corpus can be achieved. The algorithm stops when no such individual assignment change any longer provides a gain.

To execute the algorithm, after starting block 101, all sequences are initially assigned in process block 102 to no non-terminal. Then, in block 103, the auxiliary values corresponding to this initial assignment and the value of the target function to be optimized are calculated. The target function measures how well the assignment currently accepted in the algorithm corresponds to the distribution of non-terminals present in the training corpus. An example of a possible selection of this kind for the target function is the quadratic error

$$F = {\sum }_{s , c} {( {N}_{true} ( c , s ) - {N}_{current} ( c , s ) )}^{2}$$

whereby summation is performed over all sentences s of the training corpus and all non-terminals c of the grammar, Nₜᵣᵤₑ(c, s) is the actual number of occurrences of anon-terminal c in a sentence s, and N_{current}(c, s) is the number of occurrences of the non-terminal c in sentence s corresponding to the assignment currently accepted in the algorithm. At the start of the algorithm, therefore, N_{current}(c, s)=0 for all training sentences s and all non-terminals c because all of the sequences in block 102 have been assigned to no non-terminal. Conversely, for example, Nₜᵣᵤₑ(c=<Origin>, s=“I would like to travel from Berlin”)=1 since in this training sentence the non-terminal <Origin> occurs precisely once.

So this target function F summarizes the numbers of non-terminals occurring in a sentence s in the relevant vectors Nₜᵣᵤₑ(c, s) and N_{current}(c, s) (with vector index c ) and calculates the assignment error as a quadratic distance of these vectors which is summed over all sentences s of the training corpus. For this calculation, the vectors of the auxiliary values Nₜᵣᵤₑ(c, s) and N_{current}(c, s) are first created, so that the target function F can then itself be calculated.

In block 104, a sequence variable w_{current} is initialized to the first sequence of a list of all sequences. Then, in block 105, the sequence w_{current} is released from its current assignment to one or no non-terminal c_{current} and the associated change ΔFₘₒᵥₑ₋ₒᵤₜ of target function F is calculated. To achieve a standardized description method, the assignment to no non-terminal is treated at this point as an assignment to an artificial, empty non-terminal _VOID_: \tilde{c}=_VOID_.

In particular, therefore, in the event that in block 105 the sequence w_{current} already belongs to no non-terminal: \tilde{c}_{current}=_VOID_, the sequence remains assigned to no non-terminal and in this case: ΔFₘₒᵥₑ₋ₒᵤₜ=0. In the other cases, in which w_{current} belongs to a true non-terminal c_{current}, ΔFₘₒᵥₑ₋ₒᵤₜ can be efficiently calculated because it is observed that changes in the target function F arise only in sentences s in which the sequence w_{current} occurs, and specifically only in the component c=c_{current} of vector N_{current}(c, s).

In block 106, the non-terminal variable \tilde{c} is initialized at _VOID_: \tilde{c}=_VOID_, i.e. the trial assignment to no non-terminal starts (in order to test out the assignment to the first true non-terminal when this loop is next executed). In block 107, the sequence w_{current} is then assigned on a trial basis to “non-terminal” \tilde{c} and the associated change ΔFₘₒᵥₑ₋ᵢₙ(\tilde{c}) of the target function F is calculated. In particular, the following applies here again: ΔFₘₒᵥₑ₋ᵢₙ(_VOID_)=0. ΔFₘₒᵥₑ₋ᵢₙ(\tilde{c}) can also be efficiently calculated for the true non-terminals \tilde{c}=c in a similar manner, as described above for ΔFₘₒᵥₑ₋ₒᵤₜ.

In decision block 108, it is queried whether further non-terminals are still available for the non-terminal variable \tilde{c}. If this is the case, \tilde{c} is placed on the next non-terminal in a list of non-terminals in block 109, and the check again enters block 107. Otherwise, the best assignment \tilde{c}ₘᵢₙ is calculated for the sequence w_{current}:

$${\tilde{c}}_{min} = arg {min}_{\tilde{c}} ( Δ F ( \tilde{c} ) ) = arg {min}_{\tilde{c}} ( Δ {F}_{move - out} + Δ {F}_{move - i n} ( \tilde{c} ) ) ,$$

(minimization over all “non-terminals” \tilde{c}, including _VOID_).

The sum ΔFₘₒᵥₑ₋ₒᵤₜ+ΔFₘₒᵥₑ₋ᵢₙ(\tilde{c}) of the changes in target function F represents their overall change ΔF(\tilde{c}), which reaches its smallest value at \tilde{c}ₘᵢₙ:

$$Δ F ( {\tilde{c}}_{min} ) = Δ {F}_{min} = {min}_{\tilde{c}} ( Δ F ( \tilde{c} ) ) .$$

Therefore, while retaining the assignments for the remaining sequences, \tilde{c}ₘᵢₙ is the best possible choice for the assignment of w_{current}.

In decision block 111, a check is made as to whether with \tilde{c}ₘᵢₙ a better assignment than the original one to \tilde{c}_{current} has been found for the sequence w_{current}. To this end, a check is made whether ΔFₘᵢₙ<0. If this is the case, a better assignment has been found and w_{current} is then reassigned to \tilde{c}ₘᵢₙ in block 112, and the corresponding updating of the auxiliary vectors N_{current}(c, s) and the target function F is undertaken. Otherwise, no better assignment has been found and the old assignment of w_{current} to \tilde{c}_{current} and the old values of auxiliary vectors N_{current}(c, s) and the target function F are retained in block 113.

After both block 112 and block 113, the check goes to decision block 114 in which an inquiry takes place as to whether there are yet further sequences in the list of sequences to be processed. If this is the case, the next sequence in the list of sequences is assigned to sequence variable w_{current} in block 115, and the check reenters block 105. Otherwise, an inquiry takes place in decision block 116 as to whether any assignment of the sequence w has been changed in the last iteration, i.e. from block 104 to block 116. If this is the case, the check reenters block 104 to process the next iteration. Otherwise, the algorithm is terminated in end block 117.

1. A method of determining sequences of terminals or of terminals and wildcards linked to non-terminals of a grammar in a training corpus of sentences concerning which it is known in each case which non-terminals of the grammar they contain, with the following steps:
determination of sequences of terminals or of terminals and wildcards, and
assignment of the sequences of terminals or of terminals and wildcards to a non-terminal or no non-terminal by means of a classification procedure.

2. A method as claimed in claim 1, characterized in that the sequences of terminals or of terminals and wildeards are purely terminal sequences.

3. A method as claimed in claim 1, characterized in that, in determining the sequences of terminals or of terminals and wildcards, account is taken of the relative frequency of the occurrence of the sequences in the training corpus.

4. A method as claimed in claim 1, characterized in that the assignment of the sequences of terminals or of terminals and wildcards to a non-terminal or no non-terminal is determined iteratively by minimization of the function
$$F = {\sum }_{s , c} {( {N}_{true} ( c , s ) - {N}_{current} ( c , s ) )}^{2}$$
where summation is performed over all sentences s of the training corpus and all non-terminals c of the grammar, Nₜᵣᵤₑ(c, s) is the actual number of occurrences of the non-terminal c in sentence s, and N_{current}(c, s) is the number of occurrences of the non-terminal c in the sentence s corresponding to the assignment determined in the previous iteration stage.

5. A method as claimed in claim 1, characterized in that the assignment of the sequences of terminals or of terminals and wildcards to a non-terminal or no non-terminal takes place by means of classification using the exchange procedure.

6. A method as claimed in claim 5, characterized in that the exchange procedure checks the sequences of terminals or of terminals and wildcards for changes in their assignment to a non-terminal or no non-terminal in the order of their frequency in the training corpus.

7. A method as claimed in claim 1, characterized in that, following an assignment of the sequences of terminals or of terminals and wildcards, a sequence comprising two sub-sequences of terminals or of terminals and wildcards, one of which is assigned in precisely the same way as and the other of which is assigned differently from the sequence itself, is removed from the set of sequences determined.

8. A method as claimed in claim 7, characterized in that, after removal of the sequence consisting of two sub-sequences of terminals or of terminals and wildcards, one of which is assigned in precisely the same way as and the other of which is assigned differently from the sequence itself, the respective assignments of the sequences of terminals or of terminals and wildcards to a non-terminal or no non-terminal are repeated.

9. A system for determining sequences of terminals or of terminals and wildcards linked to non-terminals of a grammar in a training corpus of sentences concerning which it is known in each case which non-terminals of the grammar they contain, which is provided:
for determining sequences of terminals or of terminals and wildcards, and
for the assignment of sequences of terminals or of terminals and wildcards to a non-terminal or no non-terminal by means of a classification procedure.

10. Sequences of terminals or of terminals and wildcards linked to non-terminals of a grammar, which have been determined by means of a method comprising the steps:
determination of sequences of terminals or of terminals and wildcards, and
assignment of sequences of terminals or of terminals and wildcards to a non-terminal or no non-terminal by means of a classification procedure, in a training corpus of sentences concerning which it is known in each case which non-terminals of the grammar they contain.
